(19) United States
(12) Patent Application Publication
(10) Pub. No.: US 2021/0319773 A1
(43) Pub. Date: Oct. 14, 2021

(54) SYSTEM AND METHOD FOR INTERACTIVE COMPOSITION OF MUSIC

(71) Applicants: MICHAEL LACHOWER, RAMAT-HASHARON (IL); OFEK WASSERMAN, RAMAT-GAN (IL)

(72) Inventors: MICHAEL LACHOWER, RAMAT-HASHARON (IL); OFEK WASSERMAN, RAMAT-GAN (IL)

(21) Appl. No.: 17/273,347

(22) PCT Filed: Aug. 29, 2019
(86) PCT No.: PCT/IL2019/050973

§ 371 Date: Mar. 4, 2021

Related U.S. Application Data
(60) Provisional application No. 62/726,445, filed on Sep. 4, 2018.

(51) Int. Cl. G10H 1/00; G10H 1/36

(52) U.S. Cl. CPC G10H 1/0025; G10H 1/368; G10H 2220/425; G10H 2220/135; G10H 2220/106

(57) ABSTRACT

A method and system for composing music, including: a plurality of game pieces, each representing a musical element and including a first communication module including an identifier that is associated with the musical element; at least one game track, comprising two or more positioning elements, each located at a predetermined position on the track and designed to accommodate placement of a game piece by a user, wherein each positioning element is associated with a respective second communication module configured to communicate with the first communication module of an accommodated game piece; and a computing device configured to: receive from at least one second communication module an identification of a game piece placed at a positioning element associated with the at least one second communication module; and play a tune based on the location of the positioning element and the identification of the game piece.

### FIELD OF THE INVENTION

The present invention relates generally to composition of music. More specifically, the present invention relates to a method and a system interactive composition of music.

### BACKGROUND OF THE INVENTION

Commercially available toys enable users to compose short bits of music by placing a game piece at a selected order and playing a tune according to the order of placement.

However, such systems do not identify properties or characteristics of the placed elements, and do not associate the placed elements with respective musical elements (e.g., instrument types). Commercially available systems therefore do not visualize the complex variety of musical elements embedded in a composed musical piece.

Moreover, commercially available systems do not enable users to combine a plurality of tunes (e.g. of different musical instruments) into a comprehensive musical composition, to manipulate the length of individual notes or extend musical tunes to include a plurality of bars.

A system and a method for interactively composing a musical tune, that would enable a user to visualize a composed musical piece and would identify specific musical elements represented by respective placed game pieces is therefore required.

### SUMMARY OF THE INVENTION

Embodiments of the present invention include a system for interactively composing music, that may include:
(a) A plurality of game pieces, each representing a musical element and including a first communication module having an identifier that is associated with the musical element.
(b) At least one game track, having two or more positioning elements. Each positioning element may be located at a predetermined position on the track and may be designed to accommodate placement of a game piece by a user. Each positioning element may be associated with a respective second communication module configured to communicate with the first communication module of an accommodated game piece.
(c) A computing device configured to:
   receive from at least one second communication module an identification of a game piece that may be placed at a positioning element associated with the at least one second communication module; and
   play a tune based on the location of the positioning element and the identification of the game piece.

The computing device may be configured to repetitively play the tune according to the serial order of placement of game pieces at the positioning elements, and according to the musical elements represented by the game pieces. This may enable a user to receive immediate feedback to any change that he or she may apply to a configuration of an embodiment of the system and may facilitate interactive composition of music in real time.

At least one game piece of the plurality of game pieces may be an instrument piece, representing a musical instrument. The instrument piece may correspond with at least one musical element, including for example: an instrument's type, and at least one characteristic of the instrument's sound.

At least one game piece may be a note piece, representing a musical note. The note piece may correspond with at least one musical element, including for example: a pitch of the note, a volume of the note, a value of the note and a duration of the note.

At least one positioning element may be associated with a duration selector, configured to enable a user to prolong the duration of a musical note of a note piece that may be placed at the location of the positioning element.

According to some embodiments, a first game track may include at least one slot, and a second game track may include at least one protrusion, designed to fit in the at least one slot, to create an extended game track, including the first game track and the second game track. The computing device may be configured to play a tune based on the location of the positioning element on the extended game track and according to the identification of at least one game piece.

In some embodiments, the first communication module may include a Near Field Communication (NFC) tag and a Radio Frequency Identification (RFID) tag, and the second communication module may include a respective antenna and a respective reader. In alternate embodiments, the first communication module may include a light source (e.g. a Light Emitting Diode (LED)), and the second communication module may include a respective light detection diode.

In some embodiments, the game track may further include a processor associated with one or more second communication modules or readers, and a third communication module, associated with the game track processor and communicatively connected to the computing device.

The computing device of the game track may be configured to:
communicatively connect to a plurality of game tracks; and
synchronize the plurality of connected game tracks, so as to play a combined tune, based on the identification of game pieces and their placement at the positioning elements of the plurality of connected game tracks.

Embodiments of the system may further include a hub track, including:
at least one fourth communication module, configured to communicate data between the hub track and one or more third communication modules of respective one or more game tracks; and
a fifth communication module configured to communicate the data between the hub track and the computing device.

The computing device may be configured to play the tune according to the communicated data.

The hub track may further include at least one slot or connector, associated with a communicatively connected game track. and wherein the at least one slot or connector may be designed to enable connection of a game piece thereto, so as to associate the game piece with the respective game track.

In some embodiments, at least one game piece may be an effect piece, including:
an effect selector configured to enable a user to select at least one musical effect; and
at least one connector or protrusion, configured to connect to a respective connector or slot of a hub track, so as to associate the selected effect with a respective game track.
   The computing device may be configured to play the tune according to the selected musical effect and according to the associated game track.

In some embodiments, at least one game piece may be an avatar piece, including:

a user identifier; and

at least one connector or protrusion, configured to connect to a respective connector or slot of a hub track.

The computing device may be further configured to associate a specific configuration of the system with a specific user identifier.

The hub track may further include one or more recorder selectors, configured to enable a user to select at least one game track for recording. The hub may be configured to communicate an identification of the at least one selected track to the computing device, and the computing device may be configured to record the tune of the at least one selected track.

In some embodiments, at least one of the third communication module and fourth communication module may be a wireless communication module that may be selected from a list consisting at least one of: a Bluetooth communication module, a wireless Local Area Network (LAN) Wi-Fi communication module and a Time Divisional Multiple Access (TDMA) module.

Embodiments of the present invention may include a method of composing music by at least one processor. The method may include:
enabling a user to place one or more game pieces at respective one or more locations of positioning elements of a game track, where each game piece may represent a musical element and may include a first communication module, and where the first communication module may include an identifier that may be associated with the musical element, and wherein each positioning element may be associated with a respective second communication module, configured to communicate with the first communication module;
receiving from at least one second communication module an identification of a game piece placed at a positioning element associated with the at least one second communication module; and
playing a tune based on the location of the positioning element and on the identification of the game piece.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic, physical view of a system for interactively composing a musical tune, according to some embodiments;

FIG. 2 a schematic, physical view of a system 10 for interactively composing a musical tune, according to some embodiments;

FIG. 3 a schematic, physical view of a system 10 for interactively composing a musical tune, according to some embodiments; and

FIG. 4 is a flow diagram, depicting a method for interactively composing a musical tune by at least one processor, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention disclose a method and a system for interactive composition of music. Embodiments of the system may include one or more platforms, configured to enable a user to physically connect and/or place at least one tangible game piece thereupon, and thereby compose music according to at least one of: a type of the game piece and its location upon the one or more platforms.

The term ‘Track’ is hereby used to refer to a platform that may accommodate a placement and/or connection of one or more game pieces, to facilitate the composition of a musical tune.

Each game piece may visually represent at least one musical element, including for example: a musical instrument, a musical bar, a musical note, a musical effect and the like.

Embodiments of the system may enable a user to configure a plurality of game pieces and/or game tracks to produce a complex musical piece. For example, embodiments of the system may analyze placement of one or more game pieces (e.g. instrument pieces and note pieces) on one or more game tracks, to produce a multi-layer soundtrack, in which each layer may be associated with a specific musical instrument, as explained herein.

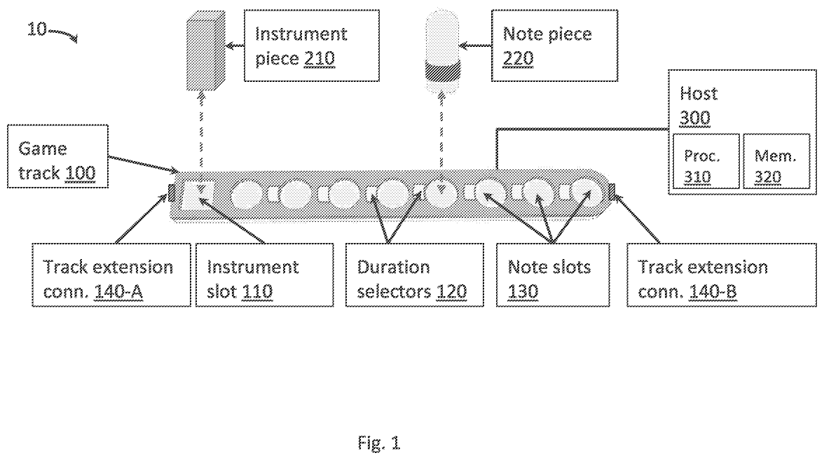

Reference is now made to FIG. 1, which depicts a schematic, physical view of a system 10 for interactively composing a musical tune, according to some embodiments. Embodiments of the system may include a plurality of game pieces (e.g. 210, 220), each representing a musical element, and a game track or platform 100, configured to connect and or accommodate a placing of at least one game piece thereon.

In some embodiments, at least one game piece may be an instrument piece, representing a specific musical instrument. The instrument piece may be associated with one or more musical element, that may characterize an instrument. For example, the musical element may be one of: an instrument's type (e.g., a guitar, a piano, etc.) and a characteristic of the instrument's sound (e.g., harmonics of notes produced by the instrument, a duration of a note produced by the instrument, and the like).

In some embodiments, at least one instrument piece may be a drum piece, representing a specific drum or a composition of drums, including for example: a snare drum, a hi hat, a Jazz set, etc.

In alternate embodiments, a musical instrument piece may represent a computer-generated or computer-synthesized sound, that may not be related to any specific musical instrument.

The at least one game piece may include a note piece, representing a musical note (e.g. Do, Re, Mi, etc.). The note piece may be associated with one or more musical elements, that may characterize the note, for example: a pitch of the note, a volume of the note, a value of the note (e.g. the relative duration of a note as normally marked by a shape of a note's head, as known to musicians), an overall duration of the note and a manner of playing (e.g. staccato, legato, etc.).

In some embodiments, the at least one game piece may include a beat piece, representing at least one rhythmic beat. For example, a user may place at a positioning element of the game track a drum instrument piece, thus configuring the track to represent one or more drums or a drum-set. The user may further place a beat piece on the game track, to configure a specific rhythmic beat. In some embodiments, the beat piece may be designed as a geometric three-dimensional shape (e.g. a cube), and may represent (e.g., according to the positioning of the shape) one of a plurality of possible beat selections.

In some embodiments, the system may include at least one game track 100, comprising two or more positioning elements (e.g., 110, 130). Each positioning element may be located at a predetermined position on the track and designed to accommodate placement of a game piece by a user.

In the example depicted in FIG. 1, the positioning elements are implemented as slots or indentations, configured to accommodate placement of a game piece therein, however it may be clear that any other form of connecting, attaching or associating between at least one game piece and a respective positioning element may have an equivalent effect. Also, in the example depicted in FIG. 1, the positioning elements are physically located in a serial, linear order, however it may be clear that any other form of predefined location of the positioning elements may have an equivalent effect.

According to some embodiments, one or more game pieces may be designed to visually represent (e.g. by a shape, a size, a color, a drawing placed thereon, and the like) their respective musical element, so as to enable a user to visualize the musical element while placing the game piece at the location of the game track.

For example, note pieces may be configured to have different heights, depending on their pitch (e.g., a note piece representing a Re note may be taller than a note piece representing a Do note), to enable a user to visualize the tune as they place the note pieces on the track.

In another example, an instrument note (e.g. a clarinet) may have a visual representation (e.g. an image of a clarinet) thereon, to enable a user to visualize the different tunes performed by a plurality of instruments.

The at least one game track 100 may be communicatively connected, by wired or wireless connection to at least one computing device, such as a host computer 300. Host 300 may include at least one non-transitory memory device 320, wherein modules of instruction code are stored, and a processor 310 associated with the memory device, and configured to execute the modules of instruction code. Processor 310 may be configured, upon execution of the modules of instruction code, to perform at least one operation of Host 300, as described herein.

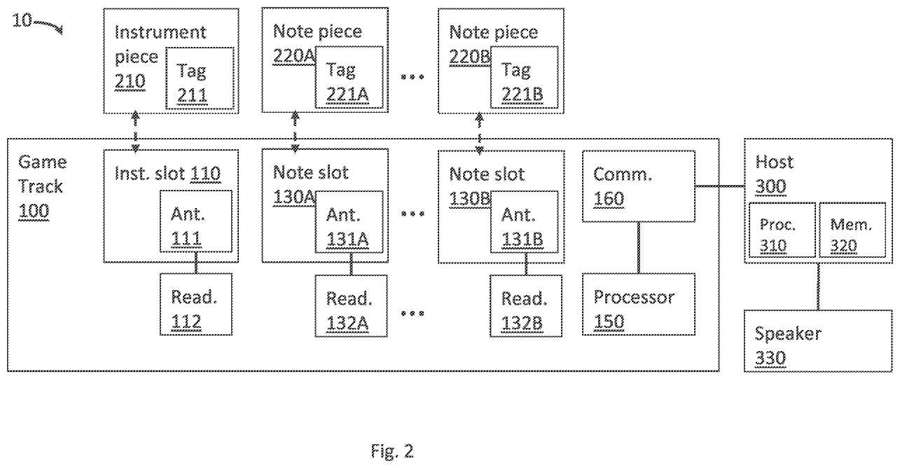

Host 300 may be configured to play a tune based on a configuration of system 10, including at least one of: the placement of game pieces at specific locations of positioning elements and the identification of each placed game piece, as explained herein. For example:
host 300 may produce an audio file according to the configuration of system 10, and store (e.g. in memory device 320) the audio file for future playback.
host 300 may store the configuration of system 10 in memory device 320, to produce an audio file based on the stored configuration upon request; and/or
store the configuration of system 10 in memory device 320, to produce streaming audio, and play a tune via a speaker device (e.g. speaker device 330 of FIG. 2).

In some embodiments, a game track may include a single positioning element (e.g. a slot, 110) configured to accommodate placement of an instrument piece (e.g. a violin) and a plurality of positioning elements (e.g. note slots 130) configured to accommodate placement of one or more note pieces (e.g., Do, Re, Mi). Host 300 may be configured to play a tune that may include the notes of the placed note pieces, in the order of their placement, as if they were played by an instrument represented by the placed instrument piece (e.g. as sounded by the violin).

In some embodiments, host 300 may be configured to repetitively play the tune according to the serial order of placement of game pieces at the positioning elements, and according to the musical elements represented by the game pieces. For example, host 300 may repeat the tune according to the placement of the note keys (e.g., Do, Re, Mi, Do, Re, Mi, Do, Re, Mi) in a loop, at a rate of a predefined number of Beats Per Minute (BPM). This may enable a user to receive immediate feedback to any change that he or she may apply to a configuration of an embodiment of the system. A user may interactively correct mistakes in the composition and may compose a piece of music interactively, in real time.

In some embodiments, at least one positioning element may be associated with a duration selector 120, configured to enable a user to prolong the duration of a musical note of a note piece that is placed at the location of the positioning element. For example, a single positioning element may represent a note duration or note value of one-eighth of a bar. A duration selector 120 may be implemented as a push-button and may be placed between two adjacent positioning elements (e.g. note slots 130). A user may press the duration selector push-button, to prolong or extend a musical note of a note piece that is placed at a first positioning element to a second, adjacent positioning element and thus prolong the note's duration from one eighth to two eights of a bar. Host 300 may be configured to play the prolonged note, as if two note pieces were placed sequentially.

Reference is now made to FIG. 2, which depicts a schematic block diagram of a system 10 for interactively composing a musical tune, according to some embodiments.

Each game piece may include a first communication module, including an identifier, associated with at least one musical element. For example, the first communication module of may be a Near-Field Communication (NFC) tag or a Radio-Frequency Identifier (RFID) tag, and may include the identifier of the respective game piece, as known in the art. For example, a first game piece may be an instrument piece representing a piano, and a second game piece may be a note piece and may represent a legato-played Do note. The identifier of each of the game pieces may identify them according to the musical element that they represent (e.g. a piano, and a legato Do note respectively).

Each positioning element (e.g. 110, 130A, 130B) may be associated with a respective second communication module, configured to communicate with a first communication module of an accommodated game piece. Pertaining to the same example, each positioning element (e.g. 110, 130A, 130B) may include an antenna (e.g. 111, 131A, 131B), and a reader (e.g. NFC reader, RFID reader, 112, 132A, 132B) that may be configured to communicate with the first communication module (e.g. the NFC tag or RFID tag).

According to some embodiments, the first communication module may include one or more light sources (e.g., Light Emitting Diodes (LEDs)), and the second communication module may include one or more respective photodiodes, configured to sense light that may be emitted by the one or more light sources. The identifier may include any parameter, or combination of parameters of the emitted light.

For example, the game piece may be identified by at least one of: a color of at least one light source (e.g.: a red LED represents a violin, a blue LED represents a trumpet, etc.), a number of active light sources (e.g., one active LED represents a Do note, two active LEDs represent a Re note, etc.), a combination of active light sources (e.g. a binary “0001” represents a Do note, a binary “0010” represents a Re note, etc.), a pattern of lighting of at least one light source (e.g., as commonly performed by Infra-red remote controllers), etc.

According to some embodiments, at least one positioning element may accommodate a placement of a plurality of game pieces and may include a respective plurality of second communication modules, each configured to communicate with the first communication module of a game piece placed at the location of the positioning element.

For example, a positioning element may include a plurality (e.g. three) of second communication modules (e.g. photodiodes) and may accommodate a placement of a respective plurality (e.g. three) of note pieces, each representing a different note (e.g. Do, Re and Mi), thus enabling a user to combine two or more musical notes together. Host 300 may be configured to play the at least two combined notes together as if they were played together by two keys (e.g. on a piano) or two instruments (e.g. two violins).

In some embodiments, at least one note piece may be a composite note piece, comprised of a plurality of note pieces, and representing a respective plurality of musical elements. For example, a user may assemble three or more note pieces to form a composite note piece that may represent a chord, as known in the art. The user may place the composite note piece at a location of a positioning element that may include one or more second communication modules configured to recognize the plurality of musical elements (e.g., the plurality of notes composing the chord), and host 300 may be configured to play the musical elements of the composite note piece (e.g., the chord).

Game track 100 may include a processor 150, that may be associated (e.g. connected) with the at least one reader (e.g. 112, 132A, 132B). Processor 150 may obtain from at least one second communication module (e.g. an NFC reader) data that may include placement of a game piece (e.g. 210, 220A, 220B) at the location of the respective positioning element (e.g. 110, 130A, 130B), and an identification of the placed game piece (e.g. whether the game piece is an instrument piece or a note piece).

According to some embodiments, processor 150 may be communicatively connected (e.g. via a third communication module 160) to a computing device such as a host computer 300. Host 300 may be configured to receive data from processor 150, including for example an identification of a game piece, and its placement at a positioning element and play (e.g. via a speaker) a tune based on, for example: the location of the positioning element and the identification of the game piece.

In some embodiments, third communication module 160 may be implemented as a wired communication module (a wired Local Area Network (LAN) connection), facilitating wired connection to host 300. In alternate embodiments, third communication module 160 may be implemented as a wireless communication module (e.g. a Bluetooth communication module, a Wi-Fi communication module, a wireless Time Divisional Multiple Access (TDMA) communication module and the like), and may facilitate wireless communication with host 300, and optionally other elements of system 10, as explained herein.

According to some embodiments, system 10 may enable a user to extend or concatenate one or more game tracks, to facilitate composition of a prolonged tune. For example, a single game track may facilitate composition of a single bar, whereas a concatenation of two game tracks may facilitate composition of two bars of music. In some embodiments, a first game track may include at least one first extension connector or slot (e.g. element 140A of FIG. 1), and a second game track may include at least one second extension connector or protrusion (e.g. element 140B of FIG. 1), designed to connect to or fit in the first extension connector or slot. Such connection of a first extension connector to a second extension connector may be recognized by at least one processor 150 and may be communicated to host 300.

Host 300 may relate to the at least two extended or concatenated tracks as an extended game track, created by the act of connecting between the extension connectors, and including the first game track and the second game track. Host 300 may be configured to consequently play a tune based on the location of the positioning elements on the extended game track and the identification of the game piece.

According to some embodiments, host 300 may be configured to communicatively connect to a plurality of game tracks 100, e.g. via the respective communication module 160 of each track 100. For example, a plurality of game tracks 100 may include a respective plurality of communication modules 160, implemented as Bluetooth client devices, and host 300 may include a Bluetooth host device that may be connected to at least some of the plurality of Bluetooth client devices. In another example, the plurality of communication modules 160 may be implemented as client Internet of Things (IoT) devices and may communicate (e.g. over Wi-Fi protocol) with host 300, either directly or via an ethernet switch (not shown).

Host 300 may be configured to synchronize a plurality of connected game tracks, so as to play a combined tune, based on the identification of game pieces and their placement at the positioning elements of the plurality of connected game tracks. For example, a first track may be configured, by placing appropriate gaming pieces, to compose a first tune played by a first instrument. A second track may be similarly configured to compose a second tune, played by a second instrument. Host 300 may receive data of the configuration of each of the connected track (e.g. via respective communication modules 160) and synchronize between the tracks to play or produce a combined tune that includes the tunes of the first and second instruments.

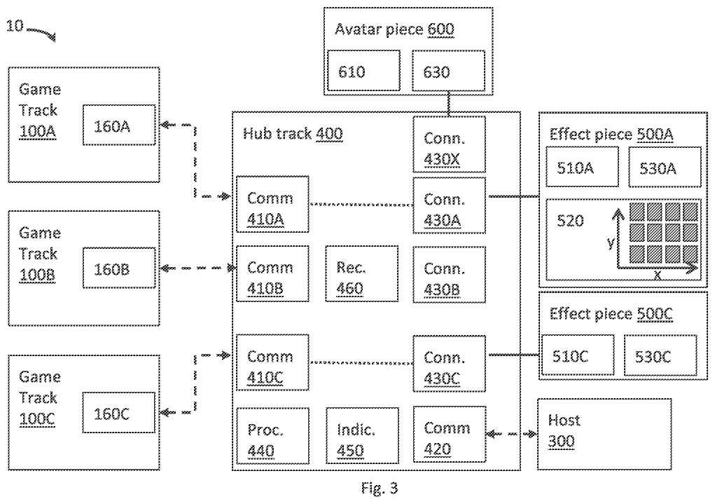

Reference is now made to FIG. 3, which depicts a schematic block diagram of a system 10 for interactively composing a musical tune, according to some embodiments.

According to some embodiments, system 10 may include at least one hub track 400. Hub track 400 may be configured to:
communicatively connect with one or more game tracks 100 (e.g., 100A, 100B, 100C) to communicate data between hub 400 and the one or more game tracks 100; and
communicatively connect with the host 300, to propagate the data of the one or more game tracks 100 to host 300.

Hub track 400 may include a processor 440, configured to implement one or more operations of the hub track 400 module, as described herein.

Hub track 400 may include one or more fourth communication modules 410 (e.g., 410A, 410B, 410C), configured to communicate data between the hub track and one or more third communication modules (e.g., 160A, 160B, 160C) of respective one or more game tracks (e.g., 100A, 100B, 100C). For example, fourth communication module 410 may be implemented as a wired communication module (e.g. a wired ethernet switch), facilitating wired connection to one or more game tracks 100. In alternate embodiments, fourth communication module 410 may be implemented as a wireless communication module (e.g. a Bluetooth, Wi-Fi, a wireless TDMA) corresponding to the implementation of the third communication module.

Hub track 400 may include a fifth communication module 420, configured to communicate with host 300, and propagate data of the one or more game tracks 100 to host 300 to play a musical tune according to the communicated data. In some embodiments, communication module 420 may be the same as fourth communication module 410. In alternate embodiments, communication module 420 may be implemented as a separate entity from fourth communication module 410.

Hub track 400 may include at least one connector 430 (e.g. 430A, 430B, 430C), designed to accommodate connection to at least one game piece. For example, connector 430 may be designed as a slot, configured to receive a protrusion of a game piece, as explained herein.

Connector or slot 430 may associate a communicatively connected game track to a respective game piece. For example, as depicted in FIG. 3, game track 100A may be connected via communication module 160A to communication module 410A of hub track 400. Connector or slot 430 of hub track 400 may be connected to game piece 500A. Hub 400 may consequently associate game piece 500A with the respective game track 100A, as explained herein.

According to some embodiments, system 10 may include one or more game pieces that are effect pieces 500 (e.g. 500A, 500C). Effect piece 500 may include an effect selector 530 (e.g., 530A, 530C) configured to enable a user to select at least one musical effect and/or at least one parameter associated with the selected effect, and a connector or protrusion 510 (e.g., 510A, 510C), configured to connect with connector or slot 430 of hub track 400. Hub track 400 may be configured to, upon connection effect piece 500 to hub track 400 (e.g. by connecting connector or protrusion 510 with connector or slot 430) to associate the effect piece (and hence the selected effect and/or effect parameter) with a respective game track 100. Host 300 may be configured to consequently play the tune according to the selected musical effect and the associated game track.

For example, a user may place an instrument piece that represents an electric guitar on game track 100A, and thus configure track 100A to represent an electric guitar. The user may communicatively connect game track 100A with hub track 400 via communication modules 160A and 410A respectively, as explained above. The user may attach or connect effect piece 500A to connector or slot 430A, to associate effect piece 500A with game track 100A, representing the electric guitar. The user may configure the selector of effect piece 500A to select a distortion effect and choose at least one parameter associated with the required distortion, such as gain, type (“fuzzy”, “growling”, or “gritty” tones), as known to electric guitar players. Host 300 may be configured to consequently play a tune as an electric guitar, according to note pieces that may be placed by the user at positioning elements of game track 100A, and according to the selected musical effect configured on effect piece 500A.

In another example, game track 100A may represent a piano and the user may configure the selector of effect piece 500A to select an effect that may be correspond with a piano. Host 300 may be configured to play the tune as a piano, according to note pieces that may be placed by the user at positioning elements of game track 100A, and according to the selected musical effect of a piano, as configured on effect piece 500A.

In some embodiments, hub piece 400 may include at least one indicator 450 (e.g. a Liquid Crystal Display (LCD) screen), configured to indicate a type of musical instrument represented by a communicatively connected game track. Pertaining to the same example, upon connection with game track 100A representing an electric guitar to hub track 400, indicator or LCD screen 450 may indicate (e.g. by displaying an icon of an electric guitar) that communicatively connected game track 100A currently represents the playing of an electric guitar. According to some embodiments, hub piece 400 may include a single indicator 450, associated with all communication modules 410. In alternate embodiments, hub piece 400 may include a plurality of indicators 450, each associated with a specific communication module 410.

System 10 may include one or more game pieces that are avatar pieces 600, configured to represent a specific user. Avatar piece 600 may include a user identifier 610 and at least one connector or protrusion 630, configured to connect to a respective connector or slot 430X of a hub track 400. User identifier 610 may include any type of electrical or mechanical element that may be used by processor 440 of hub 400 to identify a specific avatar game piece, as known in the art. For example, identifier 610 may include: a readable register set to a predefined value, an electric resistor set to a predefined value, and the like.

A user may attach or connect an avatar piece to hub track 400, so as to associate a composition of a tune or parts thereof that corresponds with at least one hub track 400, with his or her identity. For example, host 300 may be configured to associate a specific configuration (representing a composition of a tune) with a specific user identifier. In some embodiments, host 300 may store a list of configurations of system 10, and the association of such configurations with specific users, so as to reuse previous configurations, share configurations and composed tunes among online users, and the like.

According to some embodiments, hub piece 400 may include at least one recorder selector 460, configured to enable a user to select at least one game track for recording.

For example, recorder selector 460 may include a push-button, and hub piece 400 may include a plurality of recorder selectors 460, each associated with a specific communication module 410. A user may select to record a tune of at least one game track (e.g. 100A) by pushing the push-button corresponding to communication module 410A.

Processor 440 of hub track 400 may be configured to communicate (e.g. by communication module 420) an identification of the at least one selected game track (e.g. 100A) or associated communication module (e.g., 410A) to host 300.

Host 300 may record the tune of the at least one selected track (e.g. 100A) by, for example:
produce an audio file according to the configuration of system 10, as explained herein and store (e.g. in memory device 320 of FIG. 2) the audio file for future playback;
store the configuration of system 10 in memory device 320, to produce an audio file based on the stored configuration upon request; and/or
store the configuration of system 10 in memory device 320, to produce streaming audio, and play a tune (e.g. on speaker device 330 of FIG. 2).

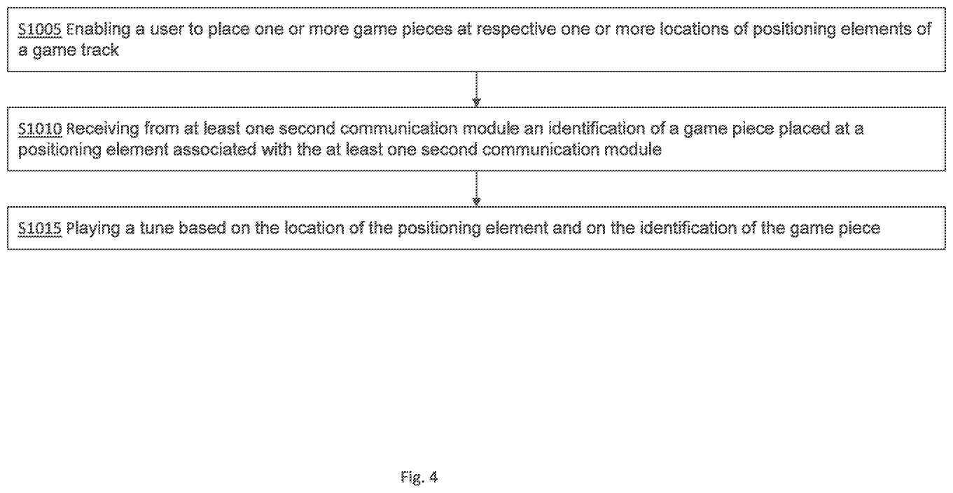

Reference is now made to FIG. 4, which is a flow diagram, depicting a method for interactively composing a musical tune by at least one processor, according to some embodiments.

As shown in step S1005, a user may place one or more game pieces (e.g. elements 210, 220 of FIG. 1) at respective one or more locations of positioning elements (e.g. elements 110 and 130 of FIG. 1) of a game track (e.g. element 100 of FIG. 1).

Each game piece may represent a musical element and may include at least one first communication module (e.g. elements 211, 221A and 221B of FIG. 2). The at least one first communication module may include an identifier (e.g. a tag) that may be associated with the musical element.

In some embodiments, each positioning element may be associated with a respective second communication module (e.g. elements 111, 131, 132 of FIG. 2), configured to communicate with the first communication module.

As shown in step S1010, at least one processor (e.g. element 150 of FIG. 2) may receive from at least one second communication module an identification of a game piece placed at a positioning element associated with the at least one second communication module.

According to some embodiments, processor 150 may be communicatively connected to a host computer (e.g. element 300 of FIG. 2), including at least one processor (e.g. element 310 of FIG. 2).

As shown in step S1015, at least one processor (e.g. element 310 of FIG. 2) may be configured to play a tune (e.g. via speaker 330 of FIG. 2), based on the location of the positioning element and on the identification of the game piece.

### Disclaimer

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for composing music, comprising:
a plurality of game pieces, each representing a musical element and comprising a first communication module comprising an identifier associated with the musical element;
at least one game track, comprising two or more positioning elements, each located at a predetermined position on the track and designed to accommodate placement of a game piece by a user, wherein each positioning element is associated with a respective second communication module configured to communicate with the first communication module of an accommodated game piece; and
a computing device configured to:
receive from at least one second communication module an identification of a game piece placed at a positioning element associated with the at least one second communication module; and
play a tune based on the location of the positioning element and the identification of the game piece.

2. The system of claim 1, wherein the computing device is configured to repetitively play the tune according to the serial order of placement of game pieces at the positioning elements, and according to the musical elements represented by the game pieces.

3. The system according to claim 1, wherein at least one game piece is an instrument piece, representing a musical instrument, and wherein the musical element is one of: an instrument's type, and at least one characteristic of the instrument's sound.

4. The system according to claim 1, wherein at least one game piece is a note piece, representing a musical note, and wherein the musical element is one of: a pitch of the note, a volume of the note, a value of the note and a duration of the note.

5. The system according to claim 1, wherein at least one positioning element is associated with a duration selector, configured to enable a user to prolong the duration of a musical note of a note piece that is placed at the location of the positioning element.

6. The system according to claim 1, wherein a first game track comprises at least one slot, and a second game track comprises at least one protrusion, designed to fit in the at least one slot, to create an extended game track comprising the first game track and the second game track, and wherein the computing device is configured to play a tune based on the location of the positioning element on the extended game track and the identification of the game piece.

7. The system according to claim 1, wherein the first communication module is one of a Near Field Communication (NFC) tag and a Radio Frequency Identification (RFID) tag, and wherein the second communication module comprises a respective antenna and a respective reader.

8. The system according to claim 1, wherein the game track further comprises:
a processor associated with one or more readers; and
a third communication module associated with the game track processor and communicatively connected to the computing device.

9. The system according to claim 1, wherein the computing device is configured to:
communicatively connect to a plurality of game tracks; and
synchronize the plurality of connected game tracks, so as to play a combined tune, based on the identification of game pieces and their placement at the positioning elements of the plurality of connected game tracks.

10. The system according to claim 1, further comprising a hub track, comprising:
at least one fourth communication module, configured to communicate data between the hub track and one or more third communication modules of respective one or more game tracks; and
a fifth communication module, configured to communicate the data between the hub track and the computing device, and wherein the computing device is further configured to play the tune according to the communicated data.

11. The system according to claim 1, wherein the hub track further comprises at least one slot, associated with a communicatively connected game track, and wherein the at least one slot is designed to enable connection of a game piece thereto, so as to associate the game piece with the respective game track.

12. The system according to claim 1, wherein at least one game piece is an effect piece, comprising:
an effect selector configured to enable a user to select at least one musical effect; and
at least one protrusion, configured to connect to a respective slot of a hub track, so as to associate the selected effect with a respective game track, and wherein the computing device is further configured to play the tune according to the selected musical effect and the associated game track.

13. The system according to claim 1, wherein the effect piece comprises a configuration interface including a two-dimensional array of selectors or buttons having a Y axis and an X axis, wherein the X axis may be associated with a selection of a specific effect, and the Y axis may be associated with a property of the selected effect.

14. The system according to claim 1, wherein at least one game piece is an avatar piece, comprising:
a user identifier; and
at least one protrusion, configured to connect to a respective slot of a hub track,
and wherein the computing device is further configured to associate a specific configuration of the system with a specific user identifier.

15. The system according to claim 1, wherein the hub track further comprises one or more recorder selectors, configured to enable a user to select at least one game track for recording, and wherein the hub is configured to communicate an identification of the at least one selected track to the computing device, and wherein the computing device is further configured to record the tune of the at least one selected track.

16. The system according to claim 1, wherein at least one of the third communication module and fourth communication module is a wireless communication module, selected from a list comprising at least one of: a Bluetooth communication module, a wireless Local Area Network (LAN) Wi-Fi communication module and a Time Divisional Multiple Access (TDMA) module.

17. A method of composing music by at least one processor, comprising:
enabling a user to place one or more game pieces at respective one or more locations of positioning elements of a game track, wherein each game piece represents a musical element and comprises a first communication module, and wherein the first communication module comprises an identifier that is associated with the musical element, and wherein each positioning element is associated with a respective second communication module, configured to communicate with the first communication module;
receiving from at least one second communication module an identification of a game piece placed at a positioning element associated with the at least one second communication module; and
playing a tune based on the location of the positioning element and on the identification of the game piece.
